(19) United States
(12) Patent Application Publication
(10) Pub. No.: US 2016/0036311 A1
(43) Pub. Date: Feb. 4, 2016

(54) MAGNETIC CLUTCH SYSTEMS AND METHODS

(71) Applicant: MagnaDrive Corporation, Woodinville, WA (US)

(72) Inventor: Jeongkwan Lee, Bellevue, WA (US)

(21) Appl. No.: 14/808,978

(22) Filed: Jul. 24, 2015

Related U.S. Application Data
(60) Provisional application No. 62/030,405, filed on Jul. 29, 2014.

(51) Int. Cl. H02K 49/10

(52) U.S. Cl. CPC H02K 49/108

(57) ABSTRACT

A magnetic clutch system having an engaged configuration and a disengaged configuration includes a first magnet rotor coupled to an input shaft and having a first sequence of magnets and a second magnet rotor coupled to an output shaft having a second sequence of magnets, the first and second sequence of magnets are arranged such that rotation of the first magnet rotor causes rotation of the second magnet rotor to drive the output shaft. The magnetic clutch system also includes a mechanism configured to facilitate slideable movement of the first magnet rotor or the second magnet rotor from the engaged configuration to the disengaged configuration.

### BACKGROUND

1. Technical Field

The present disclosure generally relates to clutch systems, and more particularly, to magnetic clutch systems.

2. Description of the Related Art

Magnetic clutches are generally employed in a wide variety of industrial applications, including automobiles, machinery, consumer products, etc. In general, magnetic clutches can include an arrangement of spaced apart magnetized components. One of the magnetized components can be mechanically coupled to an input shaft, i.e., the driving side, and the other magnetized component can be mechanically coupled to an output shaft, i.e., the driven side. Rotation of the magnetized component coupled to the input shaft generates a powerful magnetic field which causes rotation of the magnetized component coupled to the driven side, thereby generating and transmitting torque without any mechanical connection between the magnetized components. However, the attraction between the powerful magnets arranged on the magnetized components can cause the magnetized components to collapse into each other. Further, in some instances the large attraction forces between the magnetized components can inhibit, restrict, or limit disengaging the magnetized components, for example, by inhibiting, restricting, or limiting axial separation of the magnetized components. Still further, in certain applications, it is desirable to have a compact magnetic clutch system that can be located in tight spaces.

### BRIEF SUMMARY

Embodiments described herein advantageously provide magnetic clutches that transmit torque between input and output shafts in compact, efficient, and robust form factors.

In one embodiment, a magnetic clutch system having an engaged configuration and a disengaged configuration can be summarized as including a first magnet rotor coupled to the input shaft and configured to rotate therewith, the first magnet rotor including a first sequence of magnets; a second magnet rotor coupled to the output shaft and configured to rotate therewith, the second magnet rotor including a second sequence of magnets, the second sequence of magnets arranged to have opposing polarities with respect to the first sequence of magnets to generate a magnetic attraction force therebetween such that, in the engaged configuration, rotation of the first magnet rotor causes rotation of the second magnet rotor to drive the output shaft; and a mechanism coupled to the first or second magnet rotor, the mechanism configured to facilitate slideable movement of the first magnet rotor or the second magnet rotor from the engaged configuration to the disengaged configuration.

In another embodiment, a magnetic clutch system operable to transmit torque from an input shaft to an output shaft can be summarized as including a first magnet rotor coupled to the input shaft, a second magnet rotor, and a mechanism coupled to the first magnet rotor or the second magnet rotor, the mechanism configured to facilitate slideable movement of the first magnet rotor or the second magnet rotor from an engaged configuration to a disengaged configuration. The first magnet rotor can include a plurality of first magnet rotor magnets angularly spaced apart with respect to a reference axis, the plurality of first magnet rotor magnets arranged such that each of the magnets has an opposing polarity with respect to an adjacent magnet and a first internal magnet. The second magnet rotor can include a plurality of second magnet rotor magnets angularly spaced apart with respect to the reference axis, the plurality of second magnet rotor magnets arranged such that each of the second magnet rotor magnets has an opposing polarity with respect to an adjacent magnet and each of the second magnet rotor magnets has an opposing polarity with respect to the adjacent first magnet rotors when juxtaposed to one another in a static position and a second internal magnet, the second internal magnet having a same polarity as the polarity of the first internal magnet.

In yet another embodiment, a magnetic clutch system operable to transmit torque from an input shaft to an output shaft can be summarized as including an outer magnet rotor coupled to the input shaft, an inner magnet rotor coupled to the output shaft and configured to be substantially coaxial with the outer magnet rotor, and a mechanism coupled to the outer magnet rotor or the inner magnet rotor, the mechanism configured to facilitate slideable movement of the inner magnet rotor or the outer magnet rotor from an engaged configuration to a disengaged configuration. The outer magnet rotor can include a plurality of outer magnet rotor magnets angularly spaced apart with respect to a reference axis to define a first array of outer magnets, the plurality of outer magnet rotor magnets arranged such that each of the magnets has an opposing polarity with respect to an adjacent magnet. The inner magnet rotor can include a plurality of inner magnet rotor magnets angularly spaced apart with respect to the reference axis to define a first array of inner magnets, the plurality of inner magnet rotor magnets arranged such that each of the inner magnet rotor magnets has an opposing polarity with respect to an adjacent magnet and each of the inner magnet rotor magnets has an opposing polarity with respect to the adjacent outer magnet rotor magnets when juxtaposed to one another in a static position.

### BRIEF DESCRIPTION OF THE SEVERAL VIEWS OF THE DRAWINGS

FIG. 1 is a longitudinal cross-sectional view of a magnetic clutch system, according to one embodiment, with certain components removed for clarity.

FIG. 2 is partial front elevational view of a forward magnet rotor of the magnetic clutch system of FIG. 1, shown in isolation.

FIG. 3 is a partial front elevational view of an aft magnet rotor of the magnetic clutch system of FIG. 1.

FIG. 4 is a longitudinal cross-sectional view of a portion of a magnetic clutch system, according to another embodiment, with certain components removed for clarity.

FIG. 5 is a side view of the magnetic clutch system of FIG. 4, with certain components removed for clarity.

FIG. 6 is a longitudinal cross-sectional view of a portion of a magnetic clutch system, according to another embodiment, with certain components removed for clarity.

FIG. 7 is a longitudinal cross-sectional view of a magnetic clutch system shown in an engaged configuration, according to another embodiment, with certain components removed for clarity.

FIG. 8 is a longitudinal cross-sectional view of the magnetic clutch system of FIG. 7, shown in a disengaged configuration.

FIG. 9A is a partial perspective view of an arrangement of magnets of the inner and outer magnet rotors of FIG. 8.

FIG. 9B is a partial perspective view of the arrangement of magnets of the inner magnet rotor of FIG. 9A.

### DETAILED DESCRIPTION

It will be appreciated that, although specific embodiments of the subject matter of this application have been described herein for purposes of illustration, various modifications may be made without departing from the spirit and scope of the disclosed subject matter. Accordingly, the subject matter of this application is not limited except as by the appended claims.

In the following description, certain specific details are set forth in order to provide a thorough understanding of various aspects of the disclosed subject matter. However, the disclosed subject matter may be practiced without these specific details. In some instances, well-known structures and methods of attaching structures to each other comprising embodiments of the subject matter disclosed herein have not been described in detail to avoid obscuring the descriptions of other aspects of the present disclosure.

Unless the context requires otherwise, throughout the specification and claims that follow, the word “comprise” and variations thereof, such as “comprises” and “comprising” are to be construed in an open, inclusive sense, that is, as “including, but not limited to.”

Reference throughout the specification to “one embodiment” or “an embodiment” means that a particular feature, structure, or characteristic described in connection with the embodiment is included in at least one embodiment. Thus, the appearance of the phrases “in one embodiment” or “in an embodiment” in various places throughout the specification are not necessarily all referring to the same aspect. Furthermore, the particular features, structures, or characteristics may be combined in any suitable manner in one or more aspects of the present disclosure.

Reference throughout the specification to magnetic clutches includes magnetic couplers, magnetic brakes, magnetic clutch, and the like. The phrase “magnetic clutch” should not be construed narrowly to limit it to the illustrated magnetic clutch, but rather, the phrase “magnetic clutch” is broadly used to cover all types of structures that can transmit torque without a mechanical connection using principles of magnetic flux.

In the figures, identical reference numbers identify similar features or elements.

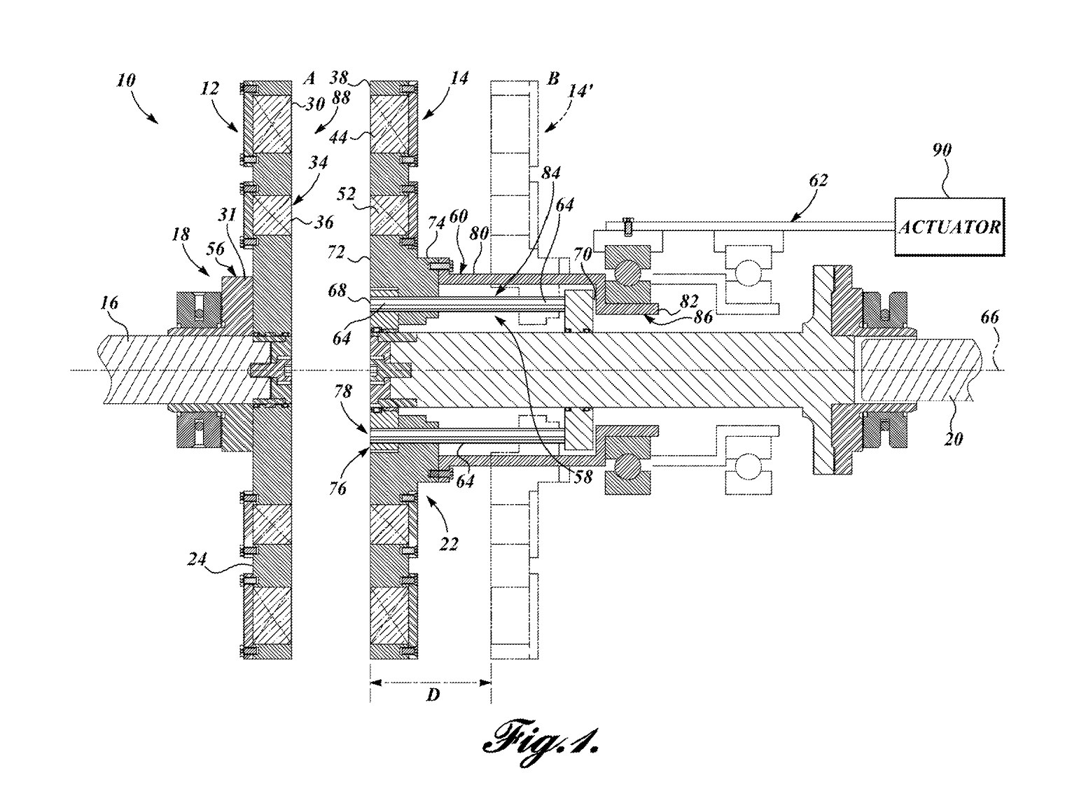

FIGS. 1 through 3 illustrate a magnetic clutch system 10 according to one embodiment. The magnetic clutch system 10 includes a pair of spaced apart magnet rotors 12, 14. The magnet rotor 12 is referred to herein as an aft magnet rotor 12 and the magnet rotor 14 is referred to herein as a forward magnet rotor 14. However, it is appreciated that the aft magnet rotor 12 and the forward magnet rotor 14 can be reversed or be interchangeable, and as such, the term forward or aft should not be construed to limit the spirit and scope of the disclosed subject matter.

The aft magnet rotor 12 is mounted on an input shaft 16 via an input shaft mounting assembly 18, such that the aft magnet rotor 12 is configured to rotate in unison with the input shaft 16. The forward magnet rotor 14 is mounted on an output shaft 20 via an output shaft mounting assembly 22, such that the forward magnet rotor 14 is configured to rotate in unison with the output shaft 20. In general, the aft and forward magnet rotors 12, 14 are mounted in a manner where rotation of the input shaft 16, for example by a motor, causes rotation of the output shaft 20, without any mechanical connection between the input and output shafts 16, 20 due to a magnetic flux generated therebetween, as will be described in more detail hereinafter.

The aft magnet rotor 12 comprises a main body 24. The main body 24 of the aft magnet rotor 12 may comprise a non-ferrous material, such as aluminum, copper, nickel, etc. The main body 24 of the aft magnet rotor 12 is generally annular and includes a plurality of pockets 26. The illustrated pockets 26 are substantially rectangularly shaped and are angularly spaced apart with respect to a reference axis 28 of the aft magnet rotor 12. While the embodiment of the aft magnet rotor 12 illustrated in FIGS. 1 through 3 includes rectangularly shaped pockets 26, in other embodiments, the pockets 26 may comprise other shapes, such as circular, triangular, etc. Further, the pockets 26 may be regularly spaced apart, e.g., equiangularly, or in other embodiments, may be irregularly spaced apart. Still further, the number of pockets 26 may vary and can be selected based on the strength requirements, e.g., the level of magnetic attraction force desired between the forward and aft magnet rotors 12, 14.

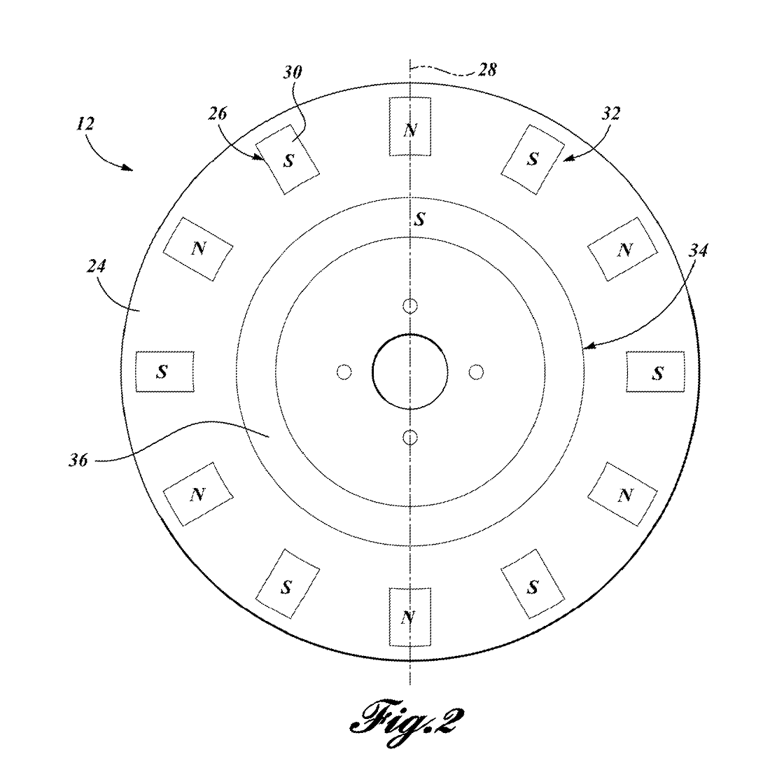

The pockets 26 are configured to receive therein respective magnets 30. The magnets 30 may be permanent magnets and may comprise neodymium, rare earth, ceramic, or other materials with suitable magnetic properties. More particularly, the magnets 30 are arranged to have alternating poles. By way of example, as best illustrated in FIG. 2, the magnets 30 are arranged to have a radial pattern of magnets having a north pole (shown in FIG. 2 as designated by the letter N) and an adjacent magnet having a south pole (shown in FIG. 2 as designated by the letter S) to complete an exterior magnetic circuit 32.

The main body 24 of the aft magnet rotor 12 has a substantially circular aperture 34 extending therethrough. The aperture 34 of the aft magnet rotor 12 is configured to receive therein an annular internal disc 36. The internal disc 36 comprises an internal magnet. Again, the internal magnet of the internal disc 36 may be a permanent magnet and may comprise neodymium, rare earth, ceramic, or other materials with suitable magnetic properties. Further, in some embodiments, the internal disc 36 may comprise a plurality and/or a series of spaced apart, segmented internal magnets. The internal magnets may be regularly or irregularly spaced apart. Still further, the internal magnets may be wedge shaped, or may comprise other suitable shapes, e.g., rectangular, circular, etc.

In the illustrated embodiment of the aft magnet rotor 12 of FIGS. 1 through 3, the internal magnet of the internal disc 36 is configured to have a south pole. However, in other embodiments, the polarity of the internal magnet of the internal disc 36 may be reversed, as is explained in further detail elsewhere in this application.

The forward magnet rotor 14 also comprises a main body 38. The main body 38 of the forward magnet rotor 14 may comprise a non-ferrous material, such as aluminum, copper, nickel, etc. The main body 38 of the forward magnet rotor 14 is generally annular and includes a plurality of pockets 40. Again, the pockets 40 are substantially rectangularly shaped and are angularly spaced apart with respect to a reference axis 42 of the forward magnet rotor 14. While the embodiment of the forward magnet rotor 14 illustrated in FIGS. 1 through 3 includes rectangularly shaped pockets 40, in other embodiments, the pockets 40 may comprise other shapes, such as circular, triangular, etc. Further, the pockets 40 may be regularly spaced apart, e.g., equiangularly, or in other embodiments, may be irregularly spaced apart. Still further, the number of pockets 40 may vary and can be selected based on the strength requirements, e.g., the level of magnetic attraction force desired between the forward and aft magnet rotors 12, 14.

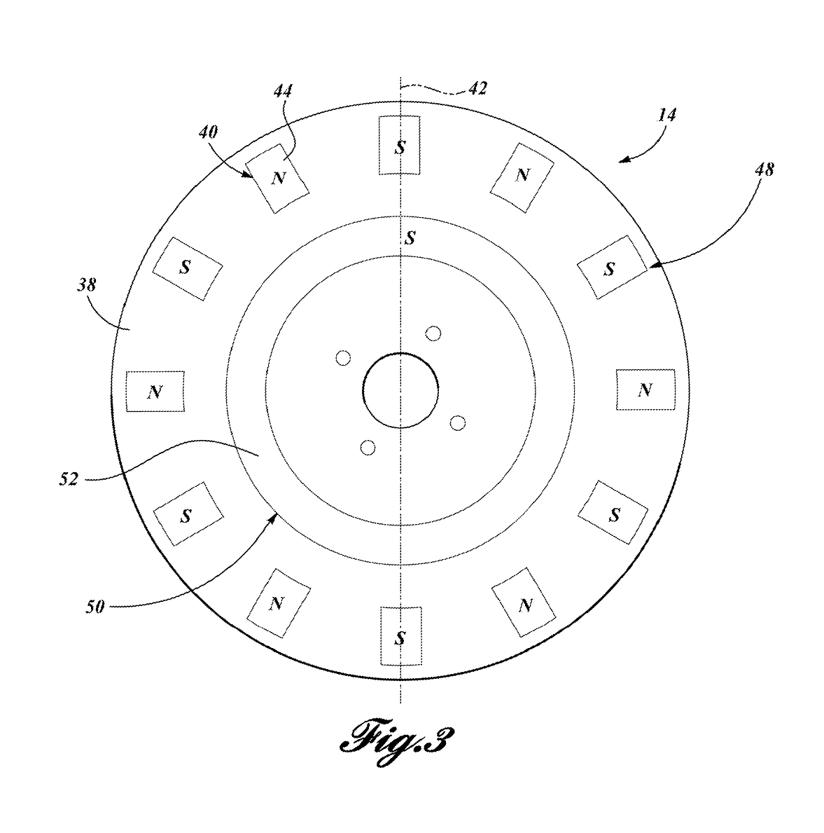

The pockets 40 of the forward magnet rotor 14 are also configured to receive therein respective magnets 44. The magnets 44 may be permanent magnets and may comprise neodymium, rare earth, ceramic, or other materials with suitable magnetic properties. More particularly, the magnets 44 of the forward magnet rotor 14 are arranged to have alternating poles radially with respect to the reference axis 42 and arranged to have opposing poles with respect to the magnets 30 of the aft magnet rotor 12 when the forward magnet rotor 14 is facing the aft magnet rotor 14 in a static position. By way of example, as illustrated in FIG. 3, the magnets 44 of the forward magnet rotor 14 are arranged to have a radial pattern of magnets having a north pole (shown in FIG. 3 as designated by the letter N) and an adjacent magnet having a south pole (shown in FIG. 3 as designated by the letter S) to complete an exterior magnetic circuit 48 of the forward magnet rotor 14. However, the radial pattern of magnets in the forward magnet rotor 14 is arranged such that the magnet 44 of polarity N in the forward magnet rotor 14 faces a magnet 30 of polarity S in the aft magnet rotor 12 when the exterior magnetic circuit 32 of the aft magnet rotor 12 is located adjacent the exterior magnetic circuit 48 of the forward magnet rotor 14 in the axial direction and in a static position.

The main body 38 of the forward magnet rotor 14 has a substantially circular aperture 50 extending therethrough. The aperture 50 of the forward magnet rotor 14 is configured to receive therein an annular internal disc 52. The internal disc 52 of the forward magnet rotor 14 comprises an internal magnet. Again, the internal magnet of the internal disc 52 of the forward magnet rotor 14 may be a permanent magnet and may comprise neodymium, rare earth, ceramic, or other materials with suitable magnetic properties. Further, in some embodiments, the internal disc 52 may comprise a plurality and/or a series of spaced apart, segmented internal magnets. The internal magnets may be regularly or irregularly spaced apart. Still further, the internal magnets may be wedge shaped, or may comprise other suitable shapes, e.g., rectangular, circular, etc.

In the illustrated embodiment of the forward magnet rotor 14 of FIGS. 1 through 3, the internal magnet of the internal disc 52 is configured to have a south pole. More particularly, the polarity of the internal magnet of the internal disc 52 of the forward magnet rotor 14 is selected to have a like polarity with the internal magnet of the internal disc 36 of the aft magnet rotor 12. It is appreciated, however, that, while the embodiment of the internal disc 36 of the aft magnet rotor 12 and the internal disc 52 of the forward magnet rotor illustrated in FIGS. 1 through 3 has a south pole, the polarities may be reversed in other embodiments.

The arrangement of the polarities of the magnets in the aft and forward magnet rotors 12, 14 is selectively arranged to generate torque and transmit power through the output shaft 20. When the input shaft 16 is rotated through a motor, for example, the poles of the magnets 30 of the aft magnet rotor 12 are angularly displaced which creates magnetic attraction forces between the magnets 44 of the forward magnet rotor 14 and the magnets 30 of the aft magnet rotor 12 (e.g., tangential forces). The magnetic attraction forces cause the forward magnet rotor 14 to rotate with the aft magnet rotor 12, and thus drive the output shaft 20. In order to prevent the aft and forward magnet rotors 12, 14 collapsing against each other and/or to facilitate separation of the forward and aft magnet rotors 12, 14, the internal magnets of the internal discs 36, 52 of the respective aft and forward magnet rotors 12, 14 are arranged to have like polarities, which causes a repulsive or an opposing axial magnetic force between the aft and forward magnet rotors 12, 14. This opposing magnetic force counters the attraction forces between the magnets 30, 44.

With continued reference to FIGS. 1 through 3, the input shaft mounting assembly 18 includes an input shaft hub 56 mounted on the input shaft 16. The input shaft hub 56 can be mounted using various techniques, such as using a wedge-type connection or a keyed connection. The input shaft hub 56 includes a flange portion 31 extending substantially perpendicularly with respect to a rotation axis 66 of the input and output shafts 16, 20. The flange portion 31 of the input shaft hub 56 is coupled to the main body 24 of the aft magnet rotor 12. The flange portion 31 of the input shaft hub 56 can be coupled to the main body 24 of the aft magnet rotor 12 using various techniques, such as by fasteners, for example. In general, the input shaft mounting assembly 18 is configured to allow the aft magnet rotor 12 to rotate in unison with the input shaft 16, but be slideably fixed in the axial direction.

The output shaft mounting assembly 20 includes a torque rod assembly 58, an outer hub member 60, and an actuator connection mechanism 62. The torque rod assembly 58 is fixedly mounted to the output shaft 20 and can be configured to rotate in unison therewith, or in alternative embodiments the torque rod assembly 58 can be configured to rotate with respect to the output shaft 20. The torque rod assembly 58 includes a pair of torque rods 64 disposed on either side of the output shaft 20 with respect to a rotation axis 66 of the output shaft 20. Each of the pair of torque rods 64 extends between a first end 68 coupled to the output shaft 20 and a second end 70 coupled to the output shaft 20 to define a certain sliding distance D. The sliding distance D is selected to control the magnetic flux and/or attraction between the forward and aft magnet rotors 14, 12.

More particularly, the main body 38 of the forward magnet rotor 14 includes a hub portion 72 which is generally annular having a bore 76 and a flange portion 74. The bore 76 of the hub portion 72 is configured to receive therein the output shaft 20 and a portion of the torque rod assembly 58. The bore 76 of the hub portion 72 is configured to be substantially coaxial with the output shaft 20, such that an interior surface of the bore 76 is located proximal an outer surface of the output shaft 20 when the forward magnet rotor 14 is mounted on the output shaft 20. The hub portion 72 of the forward magnet rotor 14 includes torque rod apertures 78 extending through the hub portion 72 and which are configured to receive therein the torque rods 64.

The outer hub member 60 is generally annular and includes a main portion 80 and a neck portion 82. The main portion 80 includes a substantially cylindrical main bore 84 configured to receive therein the output shaft 20 and the torque rod assembly 58. The cylindrical main bore 84 is configured to be substantially coaxial with the output shaft 20 when the outer hub member 60 is mounted on the output shaft 20. The main portion 80 extends between a pair of opposing ends. One of the opposing ends is configured to couple the main portion 80 of the outer hub member 60 to the flange portion 74 of the main body 38 of the forward magnet rotor 14. At the other opposing end, the main portion 80 extends to the neck portion 82 of the outer hub member 60. The neck portion 82 of the outer hub member 60 includes a bore 86 that is configured to receive therein the output shaft 20. The bore 86 is configured to be substantially coaxial with the output shaft 20 when the outer hub member 60 is mounted on the output shaft 20, such that an interior surface of the bore 86 is located proximal an outer surface of the output shaft 20. Further, an upper surface of the neck portion 82 is coupled to the actuator connecting mechanism 62. The neck portion 82 can be coupled to the actuator connecting mechanism 62 via various conventional techniques and mechanisms, such as via a bearing member, or other means known in the art. The bearing member may be configured such that an inner race portion may be rotatable while the outer race portion may not be rotatable.

The actuator connecting mechanism 62 is operatively coupled to an actuator 90. The actuator 90 is configured to controllably move the forward magnet rotor 14 such that a gap 88 between the forward magnet rotor 14 and the aft magnet rotor 12 can controllably be adjusted.

In operation, as illustrated in FIG. 1, the magnet clutch system 10 can be operable in an engaged configuration A and a disengaged configuration B (shown in phantom lines). In the engaged configuration A, the gap 88 between the forward magnet rotor 14 and the aft magnet rotor 12 is controllably selected to be at a minimum value, such that the forward magnet rotor 14 is positioned proximal to the aft magnet rotor 12. As noted above, when the input shaft 16 is rotated, the magnetic attraction forces cause rotation of the forward magnet rotor 14 and, consequently, the output shaft 20, thus transmitting and/or generating torque. To controllably reduce, limit, or cease transmission of torque to the output shaft 20, the actuator can be commanded to slideably move the forward magnet rotor 14 in the axial direction to the disengaged configuration B. More particularly, axial movement of the actuator connecting mechanism 62 which is operably coupled to the actuator 90 moves the outer hub member 60 and causes the forward magnet rotor 14 to slide along the torque rods 64 the distance D. The forward magnet rotor 14 axially moves along the torque rods 64 to the disengaged configuration B where the forward magnet rotor 14 is positioned distal from the aft magnet rotor 12 at the distance D, thereby controllably varying and/or constraining the speed of rotation of the output shaft 20.

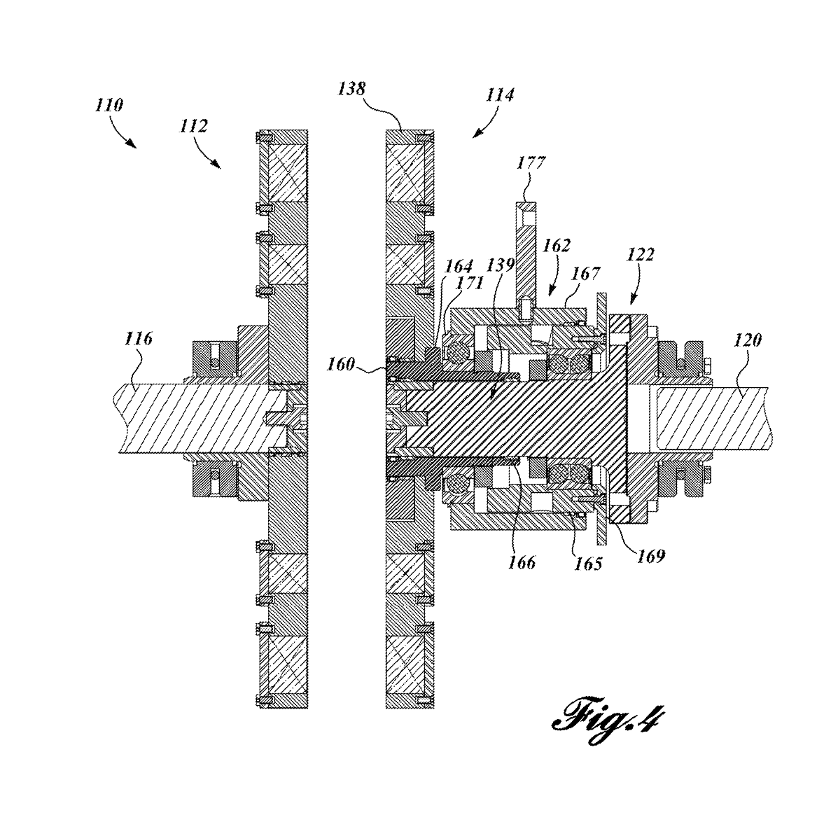

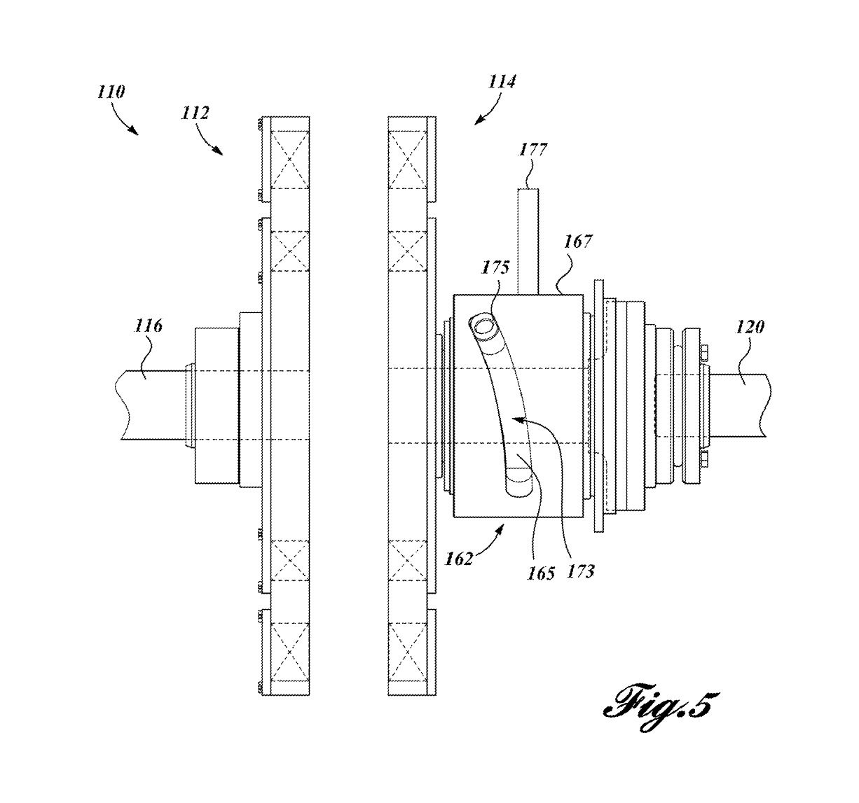

FIGS. 4 and 5 illustrate a magnetic clutch system 110 according to another example embodiment. The magnetic clutch system 110 includes an aft magnet rotor 112 mounted on an input shaft 116 and provides a variation in which a forward magnet rotor 114 is mounted on an output shaft 120 via an output shaft mounting assembly 122 according to an alternative embodiment. The output shaft mounting assembly 122 includes a magnet rotor hub 160 and a barrel cam mechanism 162. The magnet rotor hub 160 is generally annular and includes a flange element 164 and a main rotor hub body 166. The flange element 164 is configured to couple to a portion of an outer surface of a main body 138 of the forward magnet rotor 114. The main rotor hub body 166 includes a shaft bore 139 that extends therethrough. The shaft bore 139 of the main rotor hub body 166 is configured to be substantially coaxial with the output shaft 120 and configured to have an inner surface of the main rotor hub body 166 substantially abut or contact an outer surface of the output shaft 120 when the magnet rotor hub 160 is mounted on the output shaft 120.

With continued reference to FIGS. 4 and 5, the barrel cam mechanism 162 is generally configured such that the magnet rotor hub 160, the output shaft 120, and the forward magnet rotor 114 can rotate in unison with respect to the barrel cam mechanism 162. The barrel cam mechanism 162 includes an inner barrel element 165 and an outer barrel element 167. The inner barrel element 165 is mounted and secured to the output shaft 120 via a first bearing element 169. The inner barrel element 165 is configured to be fixedly coupled with respect to the output shaft 120. The outer barrel element 167 is mounted and secured to the output shaft 120 via a second bearing element 171. The outer barrel element 167 is configured to be rotatably and slideably coupled with respect to the output shaft 120.

The outer barrel element 167 includes a groove 173 which is configured to engage a cam block 175 fixedly coupled to the inner barrel element 165. The outer barrel element 167 is configured to be coupled to an arm 177, such that movement of the arm 177 causes rotation of the outer barrel element 167 and engagement of the cam block 175 with the groove 173. The arm 177 can be manually moved or may be operably coupled to an actuator which can controllably move the arm 177. As the cam block 175 slideably engages the groove 173, the outer barrel element 167 is slideably moved in the axial direction, thus causing axial displacement of the forward magnet rotor 114. In this manner, the magnetic attraction forces between the forward magnet rotor 114 and an aft magnet rotor 112 can be controllably selected by movement of the forward magnet rotor 114 in the axial direction in a similar manner to that described previously. For example, the barrel cam mechanism 162 can be used to move the forward magnet rotor 114 from an engaged configuration to a disengaged configuration, thus controllably varying and/or constraining the speed of rotation of the output shaft 120 and transmission of torque to the output shaft 120.

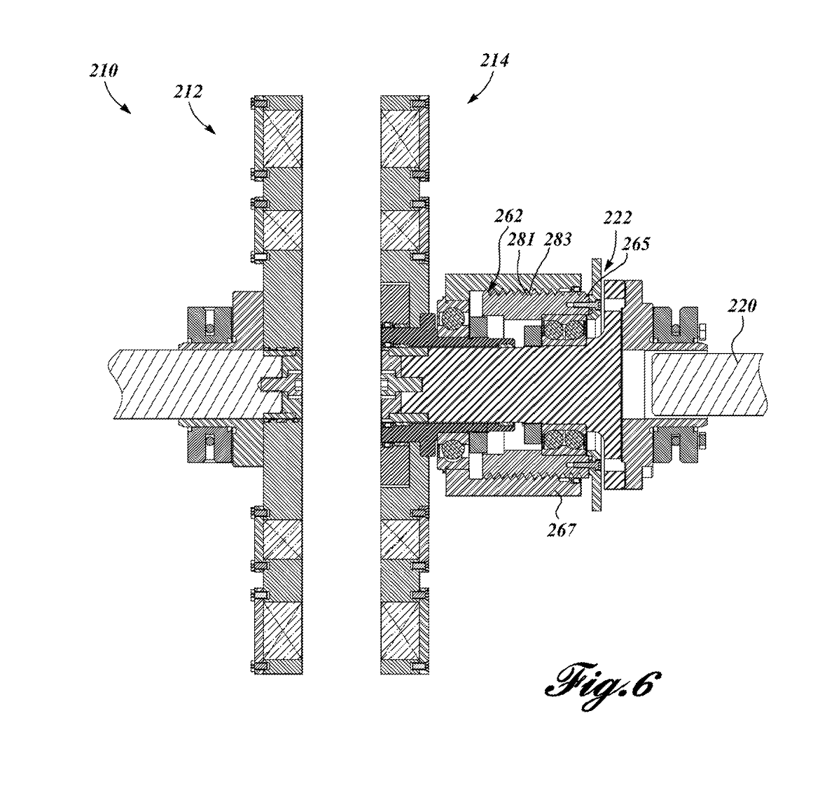

FIG. 6 illustrates a longitudinal cross-sectional view of a magnetic clutch system 210 according to another example embodiment. The magnetic clutch system 210 includes an aft magnet rotor 212 and provides a variation in which a forward magnet rotor 214 is mounted on an output shaft 220 via an output shaft mounting assembly 222 according to another embodiment. The output shaft mounting assembly 222 provides a variation in which the output shaft mounting assembly 222 includes an inner barrel element 265, an outer barrel element 267, and an engagement mechanism 262.

The engagement mechanism 262 includes an external thread arrangement 281 located on an inner surface of the outer barrel element 267 and internal thread arrangement 283 located on an outer surface of the inner barrel element 265. Again, the outer barrel element 267 can be coupled to an arm, such that movement of the arm causes rotation of the outer barrel element 267 and engagement of the external thread arrangement 281 with the internal thread arrangement 283 of the inner barrel element 265. As the external and internal thread arrangements 281, 283 engage one another, the outer barrel element 267 is slideably moved in the axial direction, thus causing axial displacement of the forward magnet rotor 214. In this manner, the magnetic attraction forces between the forward magnet rotor 214 and an aft magnet rotor 212 can be controllably selected by movement of the forward magnet rotor 214 in the axial direction in a similar manner to that described previously. For example, the engagement mechanism 262 can be used to move the forward magnet rotor 214 from an engaged configuration to a disengaged configuration, thus controllably varying and/or constraining the speed of rotation of the output shaft 220 and transmission of torque to the output shaft 220.

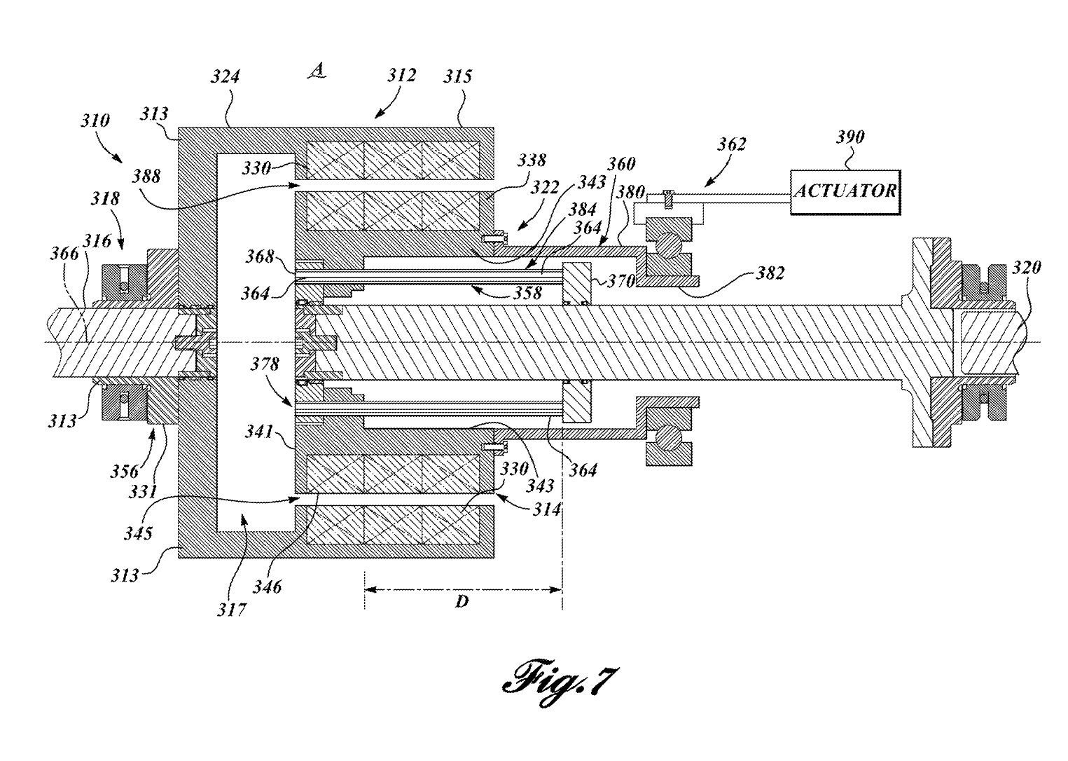

FIGS. 7 through 9B illustrate a magnetic clutch system 310 according to another example embodiment. The magnetic clutch system 310 includes an outer magnet rotor 312 and an inner magnet rotor 314. The outer magnet rotor 312 is mounted on an input shaft 316 via an input shaft mounting assembly 318, such that the outer magnet rotor 312 is configured to rotate in unison with the input shaft 316. The inner magnet rotor 314 is mounted on an output shaft 320 via an output shaft mounting assembly 322, such that the inner magnet rotor 314 is configured to rotate in unison with the output shaft 320. In general, the outer and inner magnet rotors 312, 314 are mounted in a manner where rotation of the input shaft 316, for example by a motor, causes rotation of the output shaft 320 without any mechanical connection between the input and output shafts 316, 320 due to a magnetic attraction created therebetween, as will be described in more detail hereinafter.

The outer magnet rotor 312 comprises a main body 324. The main body 324 of the outer magnet rotor 312 may comprise a non-ferrous material, such as aluminum, copper, nickel, etc. The main body 324 of the outer magnet rotor 312 is generally annular and includes a back wall portion 313 and an outer wall portion 315 to define an opening 317. The opening 317 is configured to receive therein the inner magnet rotor 314. In this manner, the magnetic clutch system 310 lends itself to savings in space and compactness, which can be suitable for applications where the magnetic clutch system 310 is to be located in tight spaces.

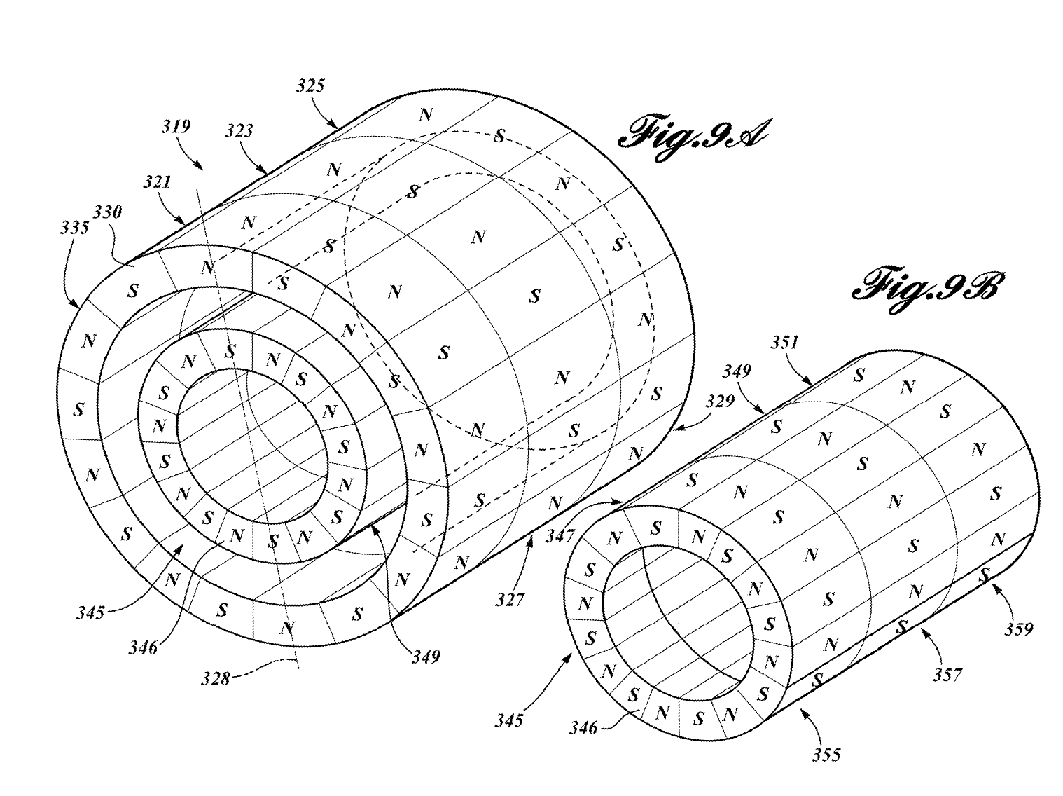

Mounted on an interior side of the outer wall portion 315, the main body 324 of the outer magnet rotor 312 is configured to receive an arrangement of magnets 319 (FIG. 9A). The arrangement of magnets 319 may be received in the interior side of the outer wall portion 315 through a plurality of spaced apart pockets configured to receive the magnets, for example. The illustrated arrangement of magnets 319 includes a first array of magnets 321, a second array of magnets 323, and a third array of magnets 325. The first, second, and third arrays of magnets 321, 323, 325 can be located adjacent to one another in the axial direction. In the radial direction, each of the first, second, and third arrays of magnets 321, 323, 325 includes a plurality of angularly spaced apart magnets 330 with respect to a reference axis 328 of the outer and inner magnetic rotors 312, 314. The magnets 330 may be permanent magnets and may comprise neodymium, rare earth, ceramic, or other materials with suitable magnetic properties. While the embodiment illustrated in FIGS. 7 through 9B includes regularly spaced apart magnets, e.g., equiangularly in other embodiments, each of the first, second, and third arrays of magnets 321, 323, 325 may be irregularly spaced apart in the radial direction. Further, the number of arrays and the number of magnets 330 may vary and can be selected based on the strength requirements, e.g., the level of output torque desired.

Each of the magnets 330 of the first, second, and third arrays of magnets 321, 323, 325 can be arranged to have alternating poles in the radial direction. By way of example, as best illustrated in FIG. 9A with respect to the first array of magnets 321, the magnets 330 are arranged to have a radial pattern of magnets having a north pole (shown in FIG. 9A as designated by the letter N) and an adjacent magnet having a south pole (shown in FIG. 9A as designated by the letter S) to complete a first exterior magnetic circuit 335. In a similar manner, the second and third arrays of magnets 323, 325 are also arranged to have radial patterns of magnets having a north pole and an adjacent magnet having a south pole to complete respective second and third exterior magnetic circuits 327, 329. In the axial direction, the first, second, and third arrays of magnets 321, 323, 325 are arranged such that the magnets 330 having a north pole in the first array of magnets 321 are positioned adjacent to a magnet 330 having a north pole in the second array of magnets 323 and, similarly, in the third array of magnets 325.

The inner magnet rotor 314 also comprises a main body 338. The main body 338 of the inner magnet rotor 314 may comprise a non-ferrous material, such as aluminum, copper, nickel, etc. The main body 338 of the inner magnet rotor 314 is generally annular and includes a back wall portion 341 and an outer wall portion 343. As noted above, main body 338 of the inner magnet rotor 314 is configured to be received in the opening 317 and to be substantially coaxial with the outer magnet rotor 312 when received therein. Mounted on an exterior side of the outer wall portion 343, the main body 338 of the inner magnet rotor 314 is configured to receive an arrangement of magnets 345. The arrangement of magnets 345 may be received in the exterior side of the outer wall portion 343 through a plurality of spaced apart pockets configured to receive the magnets, for example. As best illustrated in FIGS. 9A and 9B, the arrangement of magnets 345 can include a first array of magnets 347, a second array of magnets 349, and a third array of magnets 351. The first, second, and third arrays of magnets 349, 351, 353 can be located adjacent to one another in the axial direction. In the radial direction, each of the first, second, and third arrays of magnets 349, 351, 353 can include a plurality of angularly spaced apart magnets 346 with respect to the reference axis 328 of the outer and inner magnetic rotors 312, 314. The magnets 346 may be permanent magnets and may comprise neodymium, rare earth, ceramic, or other materials with suitable magnetic properties. While the embodiment illustrated in FIGS. 7 through 9B includes regularly spaced apart magnets, e.g., equiangularly in other embodiments, each of the first, second, and third arrays of magnets 349, 351, 353 may be irregularly spaced apart in the radial direction. Further, the number of arrays and the number of magnets 346 may vary and can be selected based on the strength requirements, e.g., the level of output torque desired.

Each of the magnets 346 of the first, second, and third arrays of magnets 349, 351, 353 can be arranged to have alternating poles in the radial direction. By way of example, as best illustrated in FIG. 9B with respect to the first array of magnets 347 of the inner magnet rotor 314, the magnets 346 are arranged to have a radial pattern of magnets having a north pole (shown in FIG. 9 as designated by the letter N) and an adjacent magnet having a south pole (shown in FIG. 9 as designated by the letter S) to complete a first exterior magnetic circuit 355. In a similar manner, the second and third arrays of magnets 349, 351 are also arranged to have radial patterns of magnets 346 having a north pole and an adjacent magnet 346 having a south pole to complete respective second and third exterior magnetic circuits 357, 359. In the axial direction, the first, second, and third arrays of magnets 347, 349, 351 are arranged such that the magnets 346 having a north pole in the first array of magnets 349 are positioned adjacent to a magnet 346 having a north pole in the second array of magnets 349 and in the third array of magnets 351. However, when the inner magnet rotor 314 is received in the opening 317 and, when in a static position, the magnets 346 of the first, second, and third arrays of magnets 349, 351, 353 of the inner magnet rotor 314 are arranged to have opposing polarities with respect to the polarities of adjacent magnets 330 of the first, second, and third arrays of magnets 321, 323, 325 of the outer magnet rotor 312.

The arrangement of the polarities of the magnets in the outer and inner magnet rotors 312, 314 is selectively arranged to generate torque and transmit power through the output shaft 320. When the input shaft 316 is rotated through a motor, for example, the poles of the magnets 330 of the first, second, and third arrays of magnets 321, 323, 325 of the outer magnet rotor 312 will be angularly displaced, which creates magnetic attraction forces between the magnets 346 of the first, second, and third arrays of magnets 347, 349, 351 of the inner magnet rotor 314 and the magnets 330 of the first, second, and third arrays of magnets 321, 323, 325 of the outer magnet rotor 312. The magnetic attraction forces cause the inner magnet rotor 314 to rotate with the outer magnet rotor 312, and thus drive the output shaft 320.

The input shaft mounting assembly 318 includes an input shaft hub 356 mounted on the input shaft 316. The input shaft hub 356 can be mounted on the input shaft 316 using various techniques, such as, using a wedge-type connection or a keyed connection. The input shaft hub 356 includes a flange portion 331 extending substantially perpendicularly with respect to a rotation axis 366 of the input and output shafts 316, 320. The flange portion 331 of the input shaft hub 356 is coupled to the back wall portion 313 of the outer magnet rotor 312. The flange portion 331 of the input shaft hub 356 can be coupled to the back wall portion 313 using various techniques, such as by fasteners, for example. In general, the input shaft mounting assembly 318 is configured to allow the outer magnet rotor 312 to rotate in unison with the input shaft 316 but be fixed in the axial direction, i.e., being slideably fixed in the axial direction.

The output shaft mounting assembly 322 includes a torque rod assembly 358, an outer hub member 360, and an actuator connection mechanism 362. The torque rod assembly 358 is fixedly mounted to the output shaft 320 and can be configured to rotate in unison therewith, or in alternative embodiments the torque rod assembly 358 can be configured to rotate with respect to the output shaft 320. The illustrated torque rod assembly 358 includes a pair of torque rods 364 disposed on either side of the output shaft 320 with respect to the rotation axis 366 of the input and output shafts 316, 320. Each of the pair of torque rods 364 extends between a first end 368 coupled to the output shaft 320 and a second end 370 coupled to the output shaft 320 to define a certain sliding distance D. The sliding distance D is selected to control the magnetic flux and/or attraction between the outer and inner magnet rotors 312, 314.

More particularly, the main body 338 of the inner magnet rotor 314 is generally annular with a bore 376 extending through the back wall portion 341. The bore 376 of the main body 338 is configured to receive therein the output shaft 320 and a portion of the torque rod assembly 358. The bore 376 of the main body 338 is configured to be substantially coaxial with the output shaft 320, such that an interior surface of the back wall portion 341 is located proximal an outer surface of the output shaft 320 when the inner magnet rotor 314 is mounted on the output shaft 320. The back wall portion 341 of the main body 338 of the inner magnet rotor 314 includes apertures 378 extending through the back wall portion 341 and which are configured to receive therein the torque rods 364.

The outer hub member 360 is generally annular and includes a main portion 380 and a neck portion 382. The main portion 380 includes a substantially cylindrical main bore 384 configured to receive therein the output shaft 320 and the torque rod assembly 358. The cylindrical main bore 384 is configured to be substantially coaxial with the output shaft 320 when the outer hub member 360 is mounted on the output shaft 320. The main portion 380 extends between a pair of opposing ends. One of the opposing ends is configured to couple the main portion 380 of the outer hub member 360 to the outer wall portion 343 of the main body 338 of the inner magnet rotor 314. At the other opposing end, the main portion 380 extends to the neck portion 382. The neck portion 382 includes a bore 386 that is configured to receive therein the output shaft 320. The bore 386 is configured to be substantially coaxial with the output shaft 320 when the outer hub member 360 is mounted on the output shaft 320, such that an interior surface of the bore 386 is located proximal an outer surface of the output shaft 320. Further, an upper surface of the neck portion 382 is coupled to the actuator connecting mechanism 362. The neck portion 382 can be coupled to the actuator connecting mechanism 362 via various conventional mechanisms, such as via a bearing member, or other means known in the art. Again, the bearing member may be configured such that an inner race portion may be rotatable while the outer race portion may not be rotatable.

The actuator connecting mechanism 362 is operatively coupled to an actuator 390. The actuator 390 is configured to controllably move the inner magnet rotor 314 such that a magnetic flux region 388 located between the first, second, and third arrays of magnets 347, 349, 351 of the inner magnet rotor 314 and the first, second, and third arrays of magnets 321, 323, 325 of the outer magnet rotor 312 can controllably be adjusted.

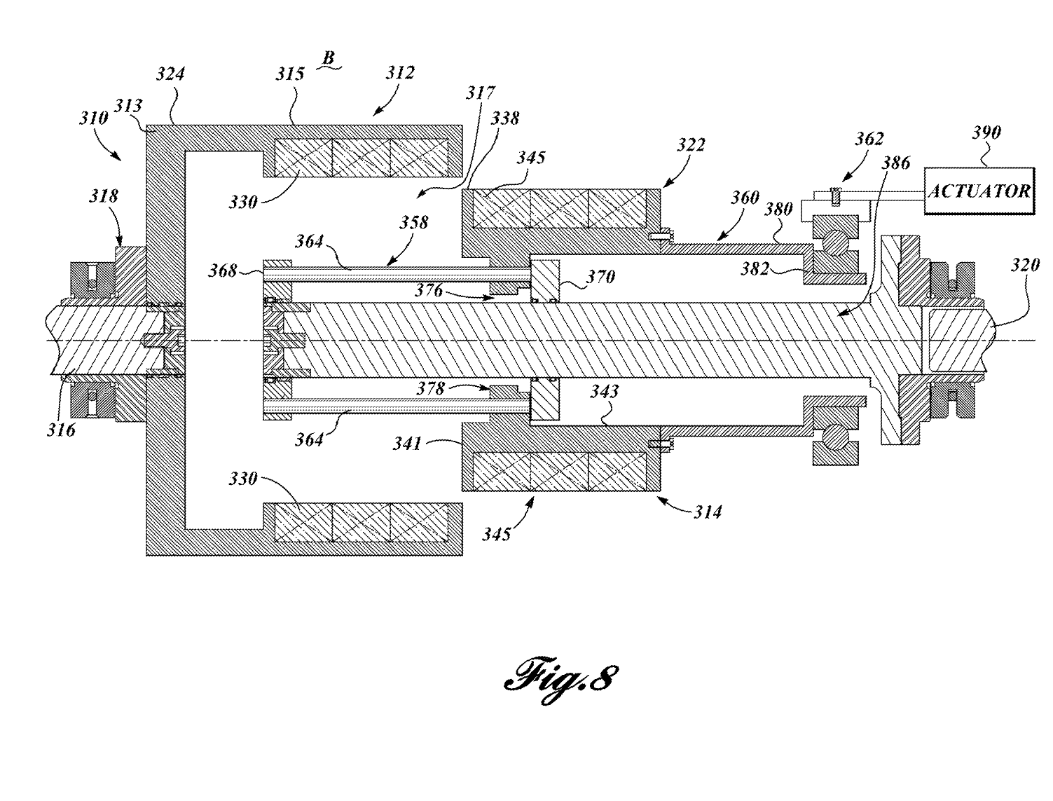

In operation, as illustrated in FIGS. 7 and 8, the magnet clutch system 310 can be operable in an engaged configuration A and a disengaged configuration B. In the engaged configuration A, the inner magnet rotor 314 is located in the magnetic flux region 388 proximal the outer magnet rotor 312 which generates a magnetic flux therebetween. As noted above, when the input shaft 316 is rotated, the magnetic flux generated causes magnetic attraction forces between the inner and outer magnet rotors 312, 314, and consequently rotation of the inner magnet rotor 314 which transmits or generates torque in the output shaft 320. To controllably reduce, limit, or cease transmission of torque to the output shaft 320, the actuator 390 can be commanded to slideably move the inner magnet rotor 314 in the axial direction to the disengaged configuration B at a distance D. More particularly, axial movement of the actuator connecting mechanism 362, which is operably coupled to the actuator 390, moves the outer hub member 360 and causes the inner magnet rotor 314 to slide along the torque rods 364 the distance D. The inner magnet rotor 314 axially moves along the torque rods 364 to the disengaged configuration B where the inner magnet rotor 314 is positioned distal from the outer magnet rotor 312 at the distance D, thereby controllably varying and/or constraining the speed of rotation of the output shaft 320.

Although the embodiment of the magnetic clutch system 310 illustrated in FIGS. 7 through 9B includes a torque rod assembly 358 configured to slideably move the inner magnet rotor 314 with respect to the outer magnet rotor 312, in alternative embodiments, the magnetic clutch system 310 can include an engagement mechanism, a barrel cam assembly or other types of cam assemblies as described above, or other mechanisms to slideably move the inner magnet rotor 314 with respect to the outer magnet rotor 312.

Moreover, the various embodiments described above can be combined to provide further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A magnetic clutch system having an engaged configuration and a disengaged configuration, the magnetic clutch system comprising:
a first magnet rotor coupled to an input shaft and configured to rotate therewith, the first magnet rotor including a first sequence of magnets;
a second magnet rotor coupled to an output shaft and configured to rotate therewith, the second magnet rotor including a second sequence of magnets, the second sequence of magnets arranged to have opposing polarities with respect to the first sequence of magnets to generate a magnetic attraction force therebetween such that, in the engaged configuration, rotation of the first magnet rotor causes rotation of the second magnet rotor to drive the output shaft; and
a mechanism coupled to the first or the second magnet rotor, the mechanism configured to facilitate slideable movement of the first magnet rotor or the second magnet rotor from the engaged configuration to the disengaged configuration.

2. The magnetic clutch system of claim 1 wherein the first and second magnet rotors include respective repulsive magnets having a same polarity as each other to generate a repulsive force.

3. The magnetic clutch system of claim 2 wherein the repulsive magnets are configured to facilitate slideable movement of the first magnet rotor or the second magnet rotor.

4. The magnet clutch system of claim 2 wherein the repulsive magnets are configured to maintain a separation between the first magnet rotor and the second magnet rotor so as to prevent the first magnet rotor or the second magnet rotor from collapsing onto one another.

5. The magnetic clutch system of claim 2 wherein the repulsive magnets comprise internal discs located in a respective body of the first and second magnet rotors.

6. The magnetic clutch system of claim 1 wherein the mechanism includes a torque rod assembly coupled to either the first magnet rotor or the second magnet rotor, the torque rod assembly configured to facilitate slideable movement of the first magnet rotor or the second magnet rotor from the engaged configuration to the disengaged configuration.

7. The magnetic clutch system of claim 1 wherein the mechanism includes a cam mechanism or an engagement mechanism.

8. The magnetic clutch system of claim 1, further comprising:
an actuator operatively coupled to the mechanism, the actuator configured to slideably move the first magnet rotor or the second magnet rotor from the engaged configuration to the disengaged configuration.

9. The magnetic clutch system of claim 1 wherein the first magnet rotor is axially spaced apart with respect to the second magnet rotor.

10. The magnetic clutch system of claim 1 wherein the first magnet rotor includes an opening configured to receive therein the second magnet rotor.

11. The magnetic clutch system of claim 10 wherein the second magnet rotor is configured to be substantially coaxial with the first magnet rotor.

12. The magnetic clutch system of claim 1 wherein the first sequence of magnets of the first magnet rotor includes a plurality of first magnet rotor magnets angularly spaced apart with respect to a first magnet rotor reference axis, each of the first magnet rotor magnets having an opposing polarity with respect to an adjacent first magnet rotor magnet and, wherein, the second sequence of magnets of the second magnet rotor includes a plurality of second magnet rotor magnets angularly spaced apart with respect to a reference axis of the second magnet rotor, each of the second magnet rotor magnets having an opposing polarity with respect to an adjacent second magnet rotor magnet.

13. A magnetic clutch system operable to transmit torque from an input shaft to an output shaft, the magnetic clutch system comprising:
a first magnet rotor coupled to the input shaft, the first magnet rotor including:
a plurality of first magnet rotor magnets angularly spaced apart with respect to a reference axis, the plurality of first magnet rotor magnets arranged such that each of the magnets has an opposing polarity with respect to an adjacent magnet;
a first internal magnet;
a second magnet rotor coupled to the output shaft, the second magnet rotor including:
a plurality of second magnet rotor magnets angularly spaced apart with respect to the reference axis, the plurality of second magnet rotor magnets arranged such that each of the second magnet rotor magnets has an opposing polarity with respect to an adjacent magnet and each of the second magnet rotor magnets has an opposing polarity with respect to the adjacent first magnet rotors when juxtaposed to one another in a static position;
a second internal magnet, the second internal magnet having a same polarity as the polarity of the first internal magnet; and
a mechanism coupled to the first magnet rotor or the second magnet rotor, the mechanism configured to facilitate slideable movement of the first magnet rotor or the second magnet rotor from an engaged configuration to a disengaged configuration.

14. The magnetic clutch system of claim 13 wherein the mechanism includes a torque rod assembly coupled to either the first magnet rotor or the second magnet rotor, the torque rod assembly configured to facilitate slideable movement of the first magnet rotor or the second magnet rotor from the engaged configuration to the disengaged configuration.

15. The magnetic clutch system of claim 13 wherein the mechanism includes a cam mechanism or an engagement mechanism.

16. The magnetic clutch system of claim 13, further comprising:
an actuator operatively coupled to the mechanism, the actuator configured to slideably move the first magnet rotor or the second magnet rotor from the engaged configuration to the disengaged configuration.

17. The magnetic clutch system of claim 13 wherein the first magnet rotor includes a main body having a plurality of pockets angularly spaced apart with respect to the reference axis, the plurality of pockets configured to receive therein the respective first magnet rotor magnets.

18. The magnetic clutch system of claim 17 wherein the main body includes an aperture configured to receive therein the first internal magnet.

19. The magnetic clutch system of claim 13 wherein the second magnet rotor includes a main body having a plurality of pockets angularly spaced apart with respect to the reference axis, the plurality of pockets configured to receive therein the respective second magnet rotor magnets.

20. The magnetic clutch system of claim 19 wherein the main body includes an aperture configured to receive therein the first internal magnet.

21. A magnetic clutch system operable to transmit torque from an input shaft to an output shaft, the magnetic clutch system comprising:
an outer magnet rotor coupled to the input shaft, the outer magnet rotor including a plurality of outer magnet rotor magnets angularly spaced apart with respect to a reference axis to define a first array of outer magnets, the plurality of outer magnet rotor magnets arranged such that each of the magnets has an opposing polarity with respect to an adjacent magnet;
an inner magnet rotor coupled to the output shaft and configured to be substantially coaxial with the outer magnet rotor, the inner magnet rotor including a plurality of inner magnet rotor magnets angularly spaced apart with respect to the reference axis to define a first array of inner magnets, the plurality of inner magnet rotor magnets arranged such that each of the inner magnet rotor magnets has an opposing polarity with respect to an adjacent magnet and each of the inner magnet rotor magnets has an opposing polarity with respect to the adjacent outer magnet rotor magnets when juxtaposed to one another in a static position; and
a mechanism coupled to the outer magnet rotor or the inner magnet rotor, the mechanism configured to facilitate slideable movement of the inner magnet rotor or the outer magnet rotor from an engaged configuration to a disengaged configuration.

22. The magnetic clutch system of claim 21 wherein:
the outer magnet rotor includes a plurality of outer magnet rotor magnets angularly spaced apart with respect to the reference axis to define a second array of outer magnets, the second array of outer magnets being located adjacent the first array of magnets and arranged such that each of the outer magnet rotor magnets has an opposing polarity with respect to an adjacent magnet and a like polarity with respect to a respective adjacent magnet of the first array of magnets; and
the inner magnet rotor includes a plurality of inner magnet rotor magnets angularly spaced apart with respect to the reference axis to define a second array of inner magnets, the second array of outer magnets being located adjacent the first array of magnets and arranged such that each of the inner magnet rotor magnets has an opposing polarity with respect to an adjacent magnet and a like polarity with respect to a respective adjacent magnet of the first array of magnets.

23. The magnetic clutch system of claim 21 wherein the mechanism includes a torque rod assembly coupled to either the outer magnet rotor or the inner magnet rotor, the torque rod assembly configured to facilitate slideable movement of the first magnet rotor or the second magnet rotor from the engaged configuration to the disengaged configuration.

24. The magnetic clutch system of claim 21 wherein the mechanism comprises a cam mechanism or an engagement mechanism.

25. The magnetic clutch system of claim 21, further comprising:
an actuator operatively coupled to the mechanism, the actuator configured to slideably move the inner magnet rotor or the outer magnet rotor from the engaged configuration to the disengaged configuration.
